(19) United States
(12) Patent Application Publication
(10) Pub. No.: US 2017/0015861 A1
(43) Pub. Date: Jan. 19, 2017

(54) ANTIFOGGING AGENT COMPOSITION, ANTIFOGGING ARTICLE, AND MANUFACTURING METHOD THEREOF

(71) Applicant: ASAHI GLASS COMPANY, LIMITED, CHIYODA-KU (JP)

(72) Inventors: YOSUKE SUGIHARA, CHIYODA-KU (JP); HIROKAZU KODAIRA, CHIYODA-KU (JP); YUSUKE MORI, CHIYODA-KU (JP); TAKASHIGE YONEDA, CHIYODA-KU (JP)

(73) Assignee: ASAHI GLASS COMPANY, LIMITED, CHIYODA-KU (JP)

(21) Appl. No.: 15/281,848

(22) Filed: Sep. 30, 2016

Related U.S. Application Data
(63) Continuation of application No. PCT/JP2015/059621, filed on Mar. 27, 2015.

(30) Foreign Application Priority Data
Apr. 1, 2014 (JP) 2014-075760

(51) Int. Cl. C09D 163/00; C08K 5/5435; B05D 1/02; B05D 3/00; B05D 1/00; B05D 1/18

(52) U.S. Cl. CPC C09D 163/00; B05D 1/005; B05D 1/18; B05D 1/02; B05D 3/007; C08K 5/5435

(57) ABSTRACT

There are provided an antifogging agent composition enabling formation of an antifogging layer excellent in yellowing resistance and bleed resistance and an antifogging article made using the same. The antifogging agent composition contains: a water-soluble epoxy resin; an aluminum compound; and an alkoxysilane compound and/or a partially hydrolyzed condensate of an alkoxysilane compound, wherein the water-soluble epoxy resin is a polyfunctional aliphatic epoxy resin. Further, the antifogging article includes: a substrate; and a resin layer disposed on at least a part of a region on the substrate, having a saturated water absorption amount of 50 mg/cm³ or more, and having a Martens hardness of 2 N/mm² or more.

### CROSS-REFERENCE TO RELATED APPLICATIONS

This application is a continuation of prior International Application No. PCT/JP2015/059621, filed on Mar. 27, 2015 which is based upon and claims the benefit of priority from Japanese Patent Application No. 2014-075760, filed on Apr. 1, 2014; the entire contents of all of which are incorporated herein by reference.

### FIELD

The present invention relates to an antifogging agent composition, an antifogging article, and a manufacturing method thereof.

### BACKGROUND

Regarding a transparent substrate such as glass or plastic, when a substrate surface is at a temperature of dew-point or less, minute water droplets adhere to the surface to scatter transmitted light, which impairs transparency, resulting in what is called a “fogging” state. As a means for preventing fogging, various proposals have been made so far.

For example, there has been known a method of providing a hygroscopic compound layer on a substrate surface and reducing atmospheric humidity on the substrate surface, to thereby prevent fogging on the substrate surface. In associated with this, there has been known a technique of forming a water-absorptive crosslinked resin on a substrate surface by a reaction of a polyepoxide compound and a curing agent, which is regarded to be excellent in antifogging property and durability (see Patent Reference 1(International Publication WO2007/052710), for example). Further, there has been known an antifogging article having an antifogging film in which a low-hygroscopic crosslinked resin layer and a high-hygroscopic resin layer are stacked on a substrate surface, which is regarded to be excellent in antifogging property and durability (see Patent Reference 2(JP-A 2008-273067), for example).

### SUMMARY OF THE INVENTION

In the prior arts, there has been a case that the hygroscopic resin layer is yellowed, thus causing a risk that transparency of the substrate decreases and an external appearance property deteriorates. On the other hand, there has been a case that for the purpose of suppressing yellowing, a use amount of a curing agent, a curing catalyst, or the like is decreased, and thereby bleed resistance decreases and precipitates are produced on the surface. An object of the present invention is to provide an antifogging agent composition enabling formation of an antifogging layer excellent in yellowing resistance and bleed resistance and an antifogging article made using the same.

Specific means for solving the above-described object are as follows, and the present invention includes the following aspects.

The first aspect of the present invention is an antifogging agent composition containing: a water-soluble epoxy resin; an aluminum compound; and an alkoxysilane compound and/or a partially hydrolyzed condensate of an alkoxysilane compound, wherein the water-soluble epoxy resin is a polyfunctional aliphatic epoxy resin.
The second aspect of the present invention is an antifogging article including: a substrate; and a resin layer disposed on at least a part of a region on the substrate, having a saturated water absorption amount of 50 mg/cm³ or more, and having a Martens hardness of 2 N/mm² or more.
The third aspect of the present invention is a manufacturing method of an antifogging article including: applying the antifogging agent composition on a substrate; and heating the applied antifogging agent composition.

According to the present invention, it is possible to provide an antifogging agent composition enabling formation of an antifogging layer excellent in yellowing resistance and bleed resistance and an antifogging article made using the same.

### DETAILED DESCRIPTION

In this description, a numerical value range expressed using “to” indicates a range that includes the numerical values described before and after “to” as the minimum value and the maximum value respectively. Further, when a plurality of materials corresponding to a component exist in a composition, a content of the component in the composition means the total amount of the plural materials existing in the composition unless otherwise specified.

[Antifogging Agent Composition]

An antifogging agent composition of the present invention contains at least one kind of water-soluble epoxy resin, at least one kind of aluminum compound, and at least one kind of alkoxysilane compound and/or a partially hydrolyzed condensate of an alkoxysilane compound (also referred to as “alkoxysilane compound and the like” together hereinafter). The antifogging agent composition may further contain other components as necessary.

The water-soluble epoxy resin is cured by the aluminum compound and the alkoxysilane compound and the like, and thereby a resin layer made of a cured product of the antifogging agent composition (also referred to as “antifogging layer”) is formed. The formed antifogging layer is excellent in adhesiveness to a substrate, yellowing resistance, and bleed resistance as well as having excellent antifogging performance. Further, the formed antifogging layer is excellent in abrasion resistance because its film hardness increases sufficiently.

This can be thought as follows, for example. It is possible to think that a silanol compound produced from the alkoxysilane compound and the like and the aluminum compound form a composite catalyst, for example, and thereby cations like protons occur, and the cations that occurred cause a polymerization reaction of epoxy groups of the water-soluble epoxy resin, and thereby curing of the antifogging agent composition progresses to make a cured product and the antifogging layer is formed. It is possible to think that the antifogging agent composition exhibits excellent curability without containing a curing agent, a curing catalyst, or the like (for example, an amine compound or an amino group-containing compound) that can cause yellowing, and thus is excellent in yellowing resistance, bleed resistance, and abrasion resistance.

(Water-Soluble Epoxy Resin)

The water-soluble epoxy resin is not limited in particular as long as it is a water-soluble resin having at least one epoxy group, and can be appropriately selected from epoxy resins used normally to be used. Here, water-soluble means that the dissolution rate (also referred to as “water-soluble rate” hereinafter) of a resin of the case when 10 parts by mass of a resin are mixed in 90 parts by mass of water (ion-exchange water) at room temperature (25° C.) is 20% or more. The water-soluble rate of the water-soluble epoxy resin is preferred to be 50% or more, more preferred to be 90% or more, and further preferred to be 98% or more. One kind of water-soluble epoxy resins may be used alone, or two or more kinds of them may be used in combination.

The water-soluble epoxy resin may be one of a monomer, an oligomer, and a polymer as long as it has at least one epoxy group. The number of epoxy groups that the water-soluble epoxy resin has can be appropriately selected according to a purpose or the like. The number of epoxy groups that the water-soluble epoxy resin has in one molecule is preferred to be 2 or more from the viewpoint of curability, more preferred to be 2 to 10, and further preferred to be 3 to 7. When a water-soluble epoxy resin having only one epoxy group is used as the water-soluble epoxy resin, at least one kind of water-soluble epoxy resins having two or more epoxy groups is preferably used in combination therewith, and with regard to the combination of two kinds or more of water-soluble epoxy resins, they are more preferably used in combination so that the average number of epoxy groups per molecule becomes 1.5 or more.

The water-soluble epoxy resin may be one of an aliphatic epoxy resin, an alicyclic epoxy resin, an aromatic epoxy resin, and the like. Here, the aliphatic epoxy resin is an epoxy resin in which at least one of an epoxy group and a glycidoxy group bonds to an aliphatic group (an alkyl group, an alkyleneoxy group, an alkylene group, or the like), the aromatic epoxy resin is an epoxy resin in which at least one of an epoxy group and a glycidoxy group bonds to an aromatic group (an aryl group such as a phenyl group, an arylene group such as a phenylene group, or the like), and the alicyclic epoxy resin is an epoxy resin that has an alicyclic group (a cyclohexyl group or the like) in a molecule and has at least one epoxy group to be formed by carbon-carbon bonding that forms an alicycle. Among these, the water-soluble epoxy resin is preferred to be the aliphatic epoxy resin, and particularly preferred to be a polyfunctional aliphatic epoxy resin. When the water-soluble epoxy resin is the aliphatic epoxy resin, the antifogging performance of the antifogging layer cured by the later-described aluminum compound tends to be more excellent.

The water-soluble epoxy resin is preferred to be a compound having a glycidyl group, more preferred to be at least one selected from the group consisting of a glycidyl ether compound, a glycidyl ester compound, and a glycidyl amino compound, further preferred to be the glycidyl ether compound, and particularly preferred to be an aliphatic glycidyl ether compound.

The glycidyl ether compound can be obtained by glycidyl-etherifying an alcohol compound. The alcohol compound using for producing the glycidyl ether compound is, from the viewpoint of durability and an antifogging property of the formed resin layer, preferred to be a bifunctional or more alcohol compound, and more preferred to be a trifunctional or more alcohol compound. The alcohol compound may be one of straight-chain or branched-chain aliphatic alcohol, alicyclic alcohol, sugar alcohol, and the like. Further, at least a part of continuous carbon chains contained in the alcohol compound may be interrupted by an oxygen atom or the like, and the alcohol compound may further have a substituent of a hydroxy group, a carboxy group, an amino group, an aromatic group such as a phenyl group, or the like.

As specific examples of the water-soluble epoxy resin, there can be cited monofunctional epoxy resins such as phenoxypoly(ethyleneoxy)glycidyl ether and lauryloxypoly(ethyleneoxy)glycidyl ether; polyfunctional epoxy resins such as ethylene glycol diglycidyl ether, polyethylene glycol diglycidyl ether, propylene glycol diglycidyl ether, polypropylene glycol diglycidyl ether, neopentyl glycol diglycidyl ether, glycerol polyglycidyl ether, diglycerol polyglycidyl ether, polyglycerol polyglycidyl ether, trimethylolpropane polyglycidyl ether, sorbitol polyglycidyl ether, and pentaerythritol polyglycidyl ether; and the like. Note that in the above-described specific examples, “poly” means more than one on average and is preferably more than two. One kind of these water-soluble epoxy resins may be used alone, or two or more kinds of them may be used in combination.

The water-soluble epoxy resin is preferred to be, from the viewpoint of antifogging performance, polyglycidyl ether of aliphatic alcohol having three or more hydroxy groups such as glycerol polyglycidyl ether, diglycerol polyglycidyl ether, polyglycerol polyglycidyl ether, or sorbitol polyglycidyl ether, and is more preferred to be at least one kind selected from ones in which the average number of glycidyl groups per molecule exceeds two.

An epoxy equivalent of the water-soluble epoxy resin is not limited in particular, and can be appropriately selected according to a purpose or the like. The epoxy equivalent of the water-soluble epoxy resin is, from the viewpoint of a crosslink density affecting the balance between the antifogging property and strength of the antifogging layer, for example, 100 to 1000, and preferred to be 130 to 250. When the water-soluble epoxy resin is an oligomer or a polymer, its weight-average molecular weight is not limited in particular, and can be appropriately selected according to a purpose or the like. The weight-average molecular weight of the water-soluble epoxy resin is, from the viewpoint of bleed resistance, for example, 100 to 70,000, and preferred to be 200 to 50,000.

As commercial products of the water-soluble epoxy resin, there can be cited, for example, aliphatic polyglycidyl ether (Denacol EX-1610 made by Nagase ChemteX Corporation, and the like), glycerol polyglycidyl ether (Denacol EX-313 made by Nagase ChemteX Corporation, and the like), polyglycerol polyglycidyl ether (Denacol EX-512 and EX-521 made by Nagase ChemteX Corporation, and the like), sorbitol polyglycidyl ether (EX-614B made by Nagase ChemteX Corporation, and the like), ethylene glycol diglycidyl ether (Denacol EX-810 and EX-811 made by Nagase ChemteX Corporation, and the like), diethylene glycol diglycidyl ether (Denacol EX-850 and EX-851 made by Nagase ChemteX Corporation, and the like), polyethylene glycol diglycidyl ether (Denacol EX-821, EX-830, EX-832, EX-841, and EX-861 made by Nagase ChemteX Corporation), polypropylene glycol diglycidyl ether (Denacol EX-920 made by Nagase ChemteX Corporation, and the like), phenoxy(ethyleneoxy)₅glycidyl ether (Denacol EX-145 made by Nagase ChemteX Corporation), lauryloxy(ethyleneoxy)₁₅glycidyl ether (Denacol EX-171 made by Nagase ChemteX Corporation), and the like. In the above, the numerals each after (ethyleneoxy) indicate the number of repetitions of an ethyleneoxy group.

The content of the water-soluble epoxy resin contained in the antifogging agent composition is not limited in particular, and can be appropriately selected according to a purpose or the like. The content of the water-soluble epoxy resin is, for example, in terms of antifogging performance of the obtained antifogging layer, preferred to be 40 mass % or more, more preferred to be 50 mass % or more, and particularly preferred to be 60 to 90 mass % in a solid content of the antifogging agent composition. Note that the solid content of the antifogging agent composition means the total mass of nonvolatile components.

(Water-Insoluble Epoxy Resin)

The antifogging agent composition may further contain at least one kind of water-insoluble epoxy resins, in addition to the water-soluble epoxy resin. Hereinafter, the water-soluble epoxy resin and the water-insoluble epoxy resin are also simply referred to as “epoxy resin component” collectively. Here, the water-insoluble epoxy resin means an epoxy resin with a water-soluble rate of less than 20%, and is preferred to be an epoxy resin with a water-soluble rate of 10% or less. The antifogging agent composition contains the water-insoluble epoxy resin, thereby making it possible to control an expansion rate of the formed antifogging layer when absorbing moisture, and excessive expansion of the antifogging layer when absorbing moisture is suppressed. This makes peeling resistance of the antifogging layer to the substrate become excellent. One kind of water-insoluble epoxy resins may be used alone, or two or more kinds of them may be used in combination.

The water-insoluble epoxy resin may be one of a monomer, an oligomer, and a polymer as long as it has at least one epoxy group. The number of epoxy groups that the water-insoluble epoxy resin has can be appropriately selected according to a purpose or the like. The number of epoxy groups that the water-insoluble epoxy resin has is preferred to be 2 or more, more preferred to be 2 to 10, and further preferred to be 3 to 7. When a water-insoluble epoxy resin having only one epoxy group is used as the water-insoluble epoxy resin, at least one kind of water-insoluble epoxy resins having two or more epoxy groups is preferably used in combination therewith, and with regard to the combination of two kinds or more of water-insoluble epoxy resins, they are more preferably used in combination so that the average number of epoxy groups per molecule becomes 1.5 or more.

The water-insoluble epoxy resin may be one of an aliphatic epoxy resin, an alicyclic epoxy resin, an aromatic epoxy resin, and the like. The water-insoluble epoxy resin is preferred to be at least one kind selected from the group consisting of an aliphatic epoxy resin and an aromatic epoxy resin, more preferred to be the aromatic epoxy resin, and particularly preferred to be a polyfunctional aromatic epoxy resin. When the water-insoluble epoxy resin is the aromatic epoxy resin, the water-soluble rate is low, and due to the existence of an aromatic ring, the expansion rate of the formed antifogging layer tends to decrease more. Therefore, when the antifogging agent composition contains the aromatic epoxy resin as the water-insoluble epoxy resin, the antifogging layer becomes more excellent in peeling resistance. Further, when the water-insoluble epoxy resin is the polyfunctional aromatic epoxy resin, reactivity improves more, so that the peeling resistance of the formed antifogging layer tends to improve more.

The water-insoluble epoxy resin is preferred to be a compound having a glycidyl group, more preferred to be at least one selected from the group consisting of a glycidyl ether compound, a glycidyl ester compound, and a glycidyl amino compound, more preferred to be the glycidyl ether compound, further preferred to be an aromatic glycidyl ether compound, and particularly preferred to be a polyfunctional aromatic glycidyl ether compound.

An epoxy equivalent of the water-insoluble epoxy resin is not limited in particular, and can be appropriately selected according to a purpose or the like. The epoxy equivalent of the water-insoluble epoxy resin is, from the viewpoint of a crosslink density affecting the balance between the antifogging property and strength of the antifogging layer, for example, 100 to 1000, and preferred to be 130 to 500. When the water-insoluble epoxy resin is an oligomer or a polymer, its weight-average molecular weight is not limited in particular, and can be appropriately selected according to a purpose or the like. The weight-average molecular weight of the water-insoluble epoxy resin is, from the viewpoint of bleed resistance from the antifogging layer, for example, 100 to 70,000, and preferred to be 500 to 10,000.

As water-insoluble aromatic epoxy resins, specifically, as monofunctional aromatic epoxy resins, phenyl glycidyl ether (Denacol EX-141 made by Nagase ChemteX Corporation, and the like) and p-t-butylphenyl glycidyl ether (Denacol EX-145 made by Nagase ChemteX Corporation, and the like) can be cited, and as polyfunctional aromatic epoxy resins, resorcinol diglycidyl ether (Denacol EX-20 made by Nagase ChemteX Corporation, and the like) and bisphenol A diglycidyl ether (EP4100 made by ADEKA CORPORATION, and the like) can be cited.

As water-insoluble aliphatic epoxy resins, for example, there can be cited allylglycidyl ether (Denacol EX-111 made by Nagase ChemteX Corporation, and the like), 2-ethylhexyl glycidyl ether (Denacol EX-121 made by Nagase ChemteX Corporation, and the like), sorbitol polyglycidyl ether (Denacol EX-622 made by Nagase ChemteX Corporation, and the like), polypropylene glycol diglycidyl ether (Denacol EX-931 (about 11 moles of a propylene oxide unit) made by Nagase ChemteX Corporation, and the like), neopentyl glycol diglycidyl ether (Denacol EX-211 made by Nagase ChemteX Corporation, and the like), 1,6-hexanediol diglycidyl ether (Denacol EX-212 made by Nagase ChemteX Corporation, and the like), hydrogenated bisphenol A diglycidyl ether (Denacol EX-252 made by Nagase ChemteX Corporation, and the like), pentaerythritol polyglycidyl ether (Denacol EX-411 made by Nagase ChemteX Corporation, and the like), and the like.

When the antifogging agent composition contains the water-insoluble epoxy resin, its content is not limited in particular, and can be appropriately selected according to the epoxy resin kind or the like. The content of the water-insoluble epoxy resin is preferred to be 10 to 90 parts by mass, more preferred to be 10 to 70 parts by mass, and particularly preferred to be 20 to 50 parts by mass relative to total 100 parts by mass of the epoxy resin component. As long as the water-insoluble epoxy resin is 10 parts by mass or more relative to total 100 parts by mass of the epoxy resin component, the peeling resistance of the antifogging layer tends to improve more, and as long as it is 90 parts by mass or less, the antifogging property of the antifogging layer tends to improve more.

Further, when the antifogging agent composition contains the water-insoluble epoxy resin, the content of the water-soluble epoxy resin contained in the antifogging agent composition is preferred to be 40 to 80 mass % in a solid content of the antifogging agent composition. Further, the content of the epoxy resin component, which is the sum of the content of the water-soluble epoxy resin and the content of the water-insoluble epoxy resin, is preferred to be 50 to 85 mass % in a solid content of the antifogging agent composition.

(Other Curable Resins)

The antifogging agent composition may further contain other curable resins other than the epoxy resin component as necessary. As cured products of other curable resins, specifically, there can be cited: a starch-based resin such as a composite of a starch-acrylonitrile graft polymer hydrolysate, a starch-acrylic acid graft polymer and the like; a cellulose-based resin such as a cellulose-acrylonitrile graft polymer or a cross-linked body of carboxymethyl cellulose; a polyvinyl alcohol-based resin such as a polyvinyl alcohol cross-linked polymer; an acrylic resin such as a polyacrylate cross-linked body or a polyacrylic ester cross-linked body; a polyether-based resin such as a polyethylene glycol diacrylate cross-linked polymer or a polyalkylene oxide-polycarboxylic acid cross-linked body; cross-linked polyurethane which is a reaction product of polyisocyanate with polyether polyol and/or polyester polyol; and the like.

When the antifogging agent composition contains other curable resins, their content can be appropriately selected according to a purpose or the like. The content of other curable resins is preferred to be 20 mass % or less and more preferred to be 5 mass % or less relative to the epoxy resin component, for example.

(Aluminum Compound)

The aluminum compound is not limited in particular as long as it can catalyze a curing reaction of the epoxy resin with a silanol compound produced from the alkoxysilane compound. The aluminum compound is preferred to be an organic aluminum compound, more preferably has at least one of an aluminum alkoxide structure and an aluminum chelate structure, and particularly preferably has at least the aluminum chelate structure.

The aluminum compound is preferred to be a compound represented by general formula (I) below from the viewpoint of more promoting curability of the antifogging agent composition.

AlXₙY₍₃₋ₙ₎ (I)

In formula (I), X each independently represents an alkoxy group having 1 to 4 carbon atoms. Y is each independently a ligand produced from a compound selected from the group consisting of M¹COCH₂COM² and M³COCH₂COOM⁴, where M¹, M², and M³ each independently represent an alkyl group having 1 to 4 carbon atoms and M⁴ represents a hydrogen atom or an alkyl group having 1 to 4 carbon atoms. n represents a number of 0 to 2.

The alkoxy group having 1 to 4 carbon atoms represented by X is a straight-chain, branched-chain, or cyclic alkoxy group. As the group represented by X, there can be cited a methoxy group, an ethoxy group, a propoxy group, an isopropyloxy group, a cyclopropyloxy group, a butoxy group, an isobutyloxy group, a sec-butyloxy group, a tert-butyloxy group, and the like specifically. Among them, it is preferred to be an alkoxy group having 2 to 4 carbon atoms.

The alkyl group having 1 to 4 carbon atoms represented by M¹ to M⁴ is a straight-chain, branched-chain, or cyclic alkyl group. As the alkyl group represented by M¹ to M⁴, there can be cited a methyl group, an ethyl group, a propyl group, an isopropyl group, a cyclopropyl group, a butyl group, an isobutyl group, a sec-butyl group, a tert-butyl group, and the like specifically. Among them, it is preferred to be an alkyl group having 1 to 3 carbon atoms. Further, the alkyl group having 1 to 4 carbon atoms represented by M¹ to M⁴ may have a substituent of a halogen atom or the like.

As the aluminum compound, specifically, there can be cited aluminum trialkoxides such as aluminum tributoxide, aluminum tritert-butoxide, aluminum trisec-butoxide, aluminum triisopropoxide, aluminum triethoxide, aluminum trimethoxide, and monosec-butoxy-di-isopropoxy aluminum; and aluminum chelates such as tris(2,4-pentanedionato)aluminum (III), aluminum hexafluoroacetylacetonate, aluminum trifluoroacetylacetonate, tris(2,2,6,6-tetramethyl-3,5-heptanedionato)aluminum (III), aluminum ethylacetoacetate diisopropylate, aluminum methylacetoacetate diisopropylate, aluminum tris(ethylacetoacetate), and aluminum monoacetylacetonatebis(ethylacetoacetate). Among these, at least one kind selected from the group of aluminum chelates is preferred. One kind of the aluminum compounds may be used alone, or two or more kinds of them may be used in combination.

As the aluminum compound, a prepared product may be used, or a commercial product may be used. As the commercial product, there can be cited ALCH, ALCH-TR, Alumichelate M, Alumichelate D and Alumichelate A(W) which are trade names of Kawaken Fine Chemicals Co., Ltd., and the like. The aluminum chelate can be prepared by causing a reaction of aluminum trialkoxide and a β-ketocarbonyl compound, for example.

The content of the aluminum compound in the antifogging agent composition is, from the viewpoint of curability and an antifogging property of the obtained antifogging layer, preferred to be 0.1 to 60 mass %, more preferred to be 1 to 55 mass %, and particularly preferred to be 2 to 50 mass % relative to the alkoxysilane compound and the like. Further, the content of the aluminum compound is, from the viewpoint of curability and an antifogging property, preferred to be 0.1 to 20 mass %, more preferred to be 0.3 to 15 mass %, and particularly preferred to be 0.5 to 10 mass % relative to the epoxy resin component.

(Alkoxysilane Compound)

The antifogging agent composition contains the alkoxysilane compound and/or the partially hydrolyzed condensate of an alkoxysilane compound. The alkoxysilane compound is a compound having one to four alkoxy groups bonding to a silicon atom in one molecule. The antifogging agent composition contains, together with the aluminum compound, the alkoxysilane compound and/or the partially hydrolyzed condensate of an alkoxysilane compound, namely the alkoxysilane compound and the like, thereby exhibiting excellent curability, resulting in that it is possible to increase adhesiveness between the substrate and the antifogging layer.

The alkoxysilane compound is preferably contained as a partially hydrolyzed condensate obtained in a manner that at least some molecules are partially hydrolyzed and then partially condensed. The antifogging agent composition contains the alkoxysilane compound in a partially hydrolyzed condensate state, and thereby the adhesiveness between the formed antifogging layer and the substrate tends to improve more.

The partially hydrolyzed condensate of an alkoxysilane compound can be obtained by making the alkoxysilane compound react with water under the existence of a catalyst. The catalyst is not limited in particular as long as it promotes hydrolysis of the alkoxysilane compound and a polycondensation reaction, and can be appropriately selected from normally used catalysts to be used.

As such a catalyst, an acid compound and a basic compound can be cited. These can be used as they are, or may be used in a state where they are each dissolved in water or an organic solvent such as alcohol, (which will be comprehensively refereed to as an acid catalyst and a basic catalyst respectively, hereinafter). The concentration of the acid compound or basic compound when used in a state where the acid compound or basic compound is dissolved in water or an organic solvent such as alcohol is not limited in particular, and may be appropriately selected according to characteristics of the acid compound or basic compound to be used, a desired content of the catalyst, or the like. Here, when the concentration of the acid compound or basic compound constituting the catalyst is high, hydrolysis and polycondensation speeds tend to be fast. The concentration of the acid compound or basic compound can be set to 0.01 to 1.0 mol/L, for example.

The kind of the acid catalyst or basic catalyst is not limited in particular. When it is necessary to use a high-concentration catalyst, a catalyst composed of such elements as to hardly remain in the antifogging layer is preferably selected. Specifically, as the acid catalyst, there can be cited inorganic acids such as a hydrogen halide like hydrochloric acid, nitric acid, sulfuric acid, sulphurous acid, hydrogen sulfide, perchioric acid, hydrogen peroxide, and carbonic acid; carboxylic acids such as formic acid and acetic acid, a substituted carboxylic acid having a substituent, a sulfonic acid such as benzenesulfonic acid, and the like. Further, as the basic catalyst, there can be cited an ammoniacal base such as ammonia water, organic amines such as ethyl amine and aniline, and the like. Further, as the catalyst, a Lewis acid catalyst made of a metal complex can also be preferably used.

When the partially hydrolyzed condensate of an alkoxysilane compound is prepared, an organic solvent may be used as necessary. As the organic solvent, there can be cited, for example, ketone solvents such as acetone, methyl ethyl ketone, and diethyl ketone, alcohol solvents such as methanol, ethanol, 2-propanol, 1-propanol, 1-butanol, and tert-butanol, halogen-containing solvents such as chloroform and methylene chloride, aromatic solvents such as benzene and toluene, ester solvents such as ethyl acetate, butyl acetate, and isopropyl acetate, ether solvents such as diethyl ether, tetrahydrofuran, and dioxane, glycol ether solvents such as ethylene glycol monomethyl ether and ethylene glycol dimethyl ether, and the like.

A reaction condition of partial hydrolysis and condensation of the alkoxysilane compound is not limited in particular as long as it is a condition capable of obtaining a desired partially hydrolyzed condensate. The amount of the water is preferred to be 4 to 20 moles and more preferred to be 7 to 16 moles relative to 1 mole of the alkoxysilane compound. The amount of the solvent is preferred to be 5 to 50 parts by mass and more preferred to be 10 to 40 parts by mass relative to 100 parts by mass of the alkoxysilane compound. The amount of the acid catalyst is preferred to be 0.1 to 5.0 parts by mass and more preferred to be 0.2 to 3.5 parts by mass relative to 100 parts by mass of the alkoxysilane compound.

A mixing temperature is not limited in particular as long as it is a temperature capable of causing a reaction of the alkoxysilane compound to obtain the partially hydrolyzed condensate, and is preferred to be 15 to 80° C. and more preferred to be 20 to 30° C. A mixing time can be set appropriately according to the mixing temperature, and is preferred to be 1 to 180 minutes and more preferred to be 5 to 120 minutes. When a mixing time is 1 minute or more, the adhesiveness between the formed antifogging layer and the substrate tends to improve more, and the peeling resistance tends to improve more, and when it is 180 minutes or less, a viscosity increase of an obtained reaction solution tends to be suppressed.

The alkoxysilane compound is preferred to be a compound represented by general formula (II) below.

(R¹O)ₚSiR²₍₄₋ₚ₎ (II)

In formula (II), R¹ each independently represents an alkyl group having 1 to 4 carbon atoms, R² each independently represents an alkyl group having 1 to 10 carbon atoms that may have a substituent, and p represents a number of 1 to 4, When a plurality of R¹ or R² exist, they may be the same or different from each other.

As the alkyl group having 1 to 4 carbon atoms represented by R¹, there can be cited a methyl group, an ethyl group, a propyl group, an isopropyl group, a butyl group, an isobutyl group, a sec-butyl group, a tert-butyl group, and the like. R¹ is preferred to be an alkyl group having 1 or 2 carbon atoms of a methyl group or an ethyl group.

The alkyl group having 1 to 10 carbon atoms represented by R² may be straight-chain, branched-chain, or cyclic, and there can be cited, for example, a methyl group, an ethyl group, a propyl group, an isopropyl group, a cyclopropyl group, a butyl group, an isobutyl group, a sec-butyl group, a tert-butyl group, a hexyl group, a cyclohexyl group, an octyl group, a decyl group, and the like. R² is preferred to be an alkyl group having 1 to 6 carbon atoms, and more preferred to be an alkyl group having 2 to 4 carbon atoms. Note that the number of carbon atoms in R² means the number of carbon atoms of an alkyl group part excluding the substituent.

R² may have a substituent. The kind of the substituent is not limited in particular, and can be appropriately selected according to a purpose or the like. As specific examples of the substituent, there can be cited an epoxy group, a glycidoxy group, a methacryloyloxy group, an acryloyloxy group, an isocyanato group, a hydroxy group, an amino group, an arylamino group, an alkylamino group, an aminoalkylamino group, a ureido group, a mercapto group, an acid anhydride group, and the like. The substituent is preferred to be at least one kind selected from the group consisting of an isocyanato group, an acid anhydride group, an epoxy group, and a glycidoxy group from the viewpoint of adhesiveness of the obtained antifogging layer. When R² has a substituent, the number of substituents is not limited in particular, and is 1 to 2, for example.

p is preferred to be 1 to 3, and more preferred to be 3. When p is 3 or less, the abrasion resistance of the formed antifogging layer tends to improve more as compared to a compound with p being 4 (namely, tetraalkoxysilane).

As specific examples of the alkoxysilane compound, there can be cited tetraalkoxysilane compounds having four alkoxy groups bonding to a silicon atom in one molecule such as tetramethoxysilane and tetraethoxysilane; trialkoxysilane compounds having three alkoxy groups bonding to a silicon atom in one molecule such as 3 -glycidoxypropyltrimethoxysilane, 3 -glycidoxypropyltriethoxysilane, 3-methacryloyloxypropyltrimethoxysilane, 3-acryloyloxypropyltrimethoxysilane, 3-isocyanatopropyltrimethoxysilane, N-(2-aminoethyl)-3-aminopropyltrimethoxysilane, 3-aminopropyltrimethoxysilane, N-phenyl-3-aminopropyltrimethoxysilane, 3-ureidopropyltriethoxysilane, and 3-mercaptopropyltrimethoxysilane; dialkoxysilane compounds having two alkoxy groups bonding to a silicon atom in one molecule such as 3-glycidoxypropylmethyldiethoxysilane, 3-methacryloyloxypropylmethyldimethoxysilane, N-(2-aminoethyl)-3-aminopropylmethyldimethoxysilane, and 3-aminopropylmethyldimethoxysilane; and the like.

Among these, the trialkoxysilane compounds are preferred, the trialkoxysilane compound having an epoxy group as a substituent is more preferred, and at least one kind selected from 3-glycidoxypropyltrimethoxysilane and 3-glycidoxypropyltriethoxysilane is particularly preferred. One kind of the alkoxysilane compounds may be used alone, or two or more kinds of them may be used in combination.

The content of the alkoxysilane compound and the like in the antifogging agent composition is not limited in particular, and can be appropriately selected according to the aluminum compound or the like. The content of the alkoxysilane compound and the like is preferred to be 5 to 40 parts by mass and more preferred to be 8 to 30 parts by mass relative to total 100 parts by mass of the epoxy resin component. As long as the content of the alkoxysilane compound and the like is 5 parts by mass or more relative to total 100 parts by mass of the epoxy resin component, the adhesiveness between the antifogging layer and the substrate tends to improve more and the peeling resistance tends to improve more, and as long as it is 40 parts by mass or less, coloring of the antifogging layer caused by oxidation of the resin tends to be decreased even when the antifogging layer is exposed to high temperature.

Incidentally, when the alkoxysilane compound and the like are the partially hydrolyzed condensate of an alkoxysilane compound, the content of the alkoxysilane compound and the like in the antifogging agent composition is calculated using the amount of an alkoxysilane compound being a raw material used for obtaining the partially hydrolyzed condensate as the amount of the partially hydrolyzed condensate.

(More Components)

The antifogging agent composition can contain more components as necessary within a range where the effect of the present invention is exhibited. As such components, there can be cited a curing agent of the epoxy resin (to be just refereed to as “curing agent” hereinafter), a solvent, a filler, a leveling agent, a surfactant, a UV absorbent, a light stabilizer, an antioxidant, and the like.

<Curing Agent>

The antifogging agent composition may contain a curing agent as necessary. The curing agent is not limited in particular as long as it reacts with the epoxy resin to enable formation of a cured product, and can be appropriately selected from normally used epoxy resin curing agents to be used. As a reactive group that the curing agent has, there can be cited a carboxy group, an amino group, an acid anhydride group, a hydroxy group, and the like. The number of reactive groups that one molecule of the curing agent has is preferred to be 1.5 or more on average and more preferred to be 2 to 8. When the number of reactive groups is 1.5 or more, the antifogging layer excellent in the balance between the antifogging property and the abrasion resistance can be obtained.

As the curing agent, specifically, there can be cited a polyamine-based compound, a polycarboxylic acid-based compound (including a polycarboxylic acid anhydride), a polyol-based compound, a polyisocyanate-based compound, a polyepoxy-based compound, dicyandiamides, organic acid dihydrazides, and the like. Among them, the polyamine-based compound, the polyol-based compound, the polycarboxylic acid anhydride, and the like are preferred, and the polyol-based compound and the polycarboxylic acid anhydride are more preferred. One kind of the curing agents may be used alone, or two or more kinds of them may be used in combination.

As the polyamine-based compound, an aliphatic polyamine-based compound and an alicyclic polyamine-based compound are preferred. Specifically, ethylenediamine, triethylenetetramine, tetraethylenepentamine, hexamethylenediamine, isophoronediamine, mensenediamine, metaphenylenediamine, polyoxypropylenepolyamine, polyoxy glycol polyamine, 3,9-bis(3-aminopropyl)-2,4,8,10-tetraoxaspiro(5,5)undecane, or the like is preferred.

As the polycarboxylic acid-based compound, oxalic acid, malonic acid, succinic acid, malic acid, citric acid, methyltetrahydrophthalic anhydride, hexahydrophthalic anhydride, 4-methylhexahydrophthalic anhydride, or the like is preferred.

As the polyol-based compound, a trihydric or higher-hydric alcohol, polyether polyol, polyester polyol, and the like are cited, and the polyether polyol is preferred. The polyether polyol is not limited in particular, and can be obtained by making the trihydric or higher-hydric alcohol react with alkylene oxide (ethylene oxide, propylene oxide, or the like).

As the trihydric or higher-hydric alcohol, there can be cited glycerin, trimethylolethane, trimethylolpropane, diglycerol, triglycerol, ditrimethylolpropane, 1,2,6-hexanetriol, pentaerythritol, dipentaerythritol, and the like. The trihydric or higher-hydric alcohols may be one kind alone, or two or more kinds of them may be combined.

As a commercial product of the polyol-based compound, there can be cited, for example, “SANNIX GP-250,” “SANNIX GP-400,” “SANNIX GP-600,” “SANNIX GP-1000,” and “SANNIX GP-1500,” which are made by Sanyo Chemical Industries, Ltd., “TMP-30,” “TMP-60,” and “TMP-90,” which are made by NIPPON NYUKAZAI CO.,LTD., and the like.

When the antifogging agent composition contains the curing agent, its content is preferred to be 0.1 to 30 parts by mass and more preferred to be 0.2 to 28 parts by mass relative to 100 parts by mass of the epoxy resin component. For the antifogging agent composition, the content of the curing agent is also preferred to be 30 parts by mass or less and more preferred to be 0.5 parts by mass or less relative to 100 parts by mass of the epoxy resin component, and not containing substantially is particularly preferred. Here, “not containing substantially” means that inevitable mixing of a compound capable of functioning as the curing agent is not excluded.

<Solvent>

The antifogging agent composition may contain the solvent. The antifogging agent composition contains the solvent, and thereby coating workability tends to improve. The solvent is not limited in particular as long as it has good solubility of components such as the resin component and the curing agent and has low reactivity with respect to these components. As the solvent, specifically, there can be cited alcohol solvents such as methanol, ethanol, and 2-propanol; ester solvents such as ethyl acetate and butyl acetate; ether solvents such as diethyleneglycol dimethylether; ketone solvents such as methyl ethyl ketone, water (ion-exchange water or the like), and the like. One kind of the solvents may be used alone, or two or more kinds of them may be used in combination.

When the antifogging agent composition contains the solvent, the content of the solvent is preferred to be, for example, 0.1 to 500 parts by mass and more preferred to be 1 to 300 parts by mass relative to 100 parts by mass of the solid content of the antifogging agent composition.

<Filler>

The antifogging agent composition may contain the filler. When the antifogging agent composition contains the filler, there is a tendency that mechanical strength and heat resistance of the antifogging layer can be increased and curing shrinkage of the resin component can be reduced. As the filler, an inorganic filler and an organic filler can be cited, and the inorganic filler is preferred. As the inorganic filler, silica, alumina, titania, zirconia, ITO (indium tin oxide), and the like can be cited, and the silica or ITO is preferred. When the filler is silica, a water absorbing property tends to be given to the antifogging layer. Further, since ITO has infrared absorbency, heat ray absorbency is given to the antifogging layer and an antifogging effect by heat ray absorption can also be expected.

An average particle diameter of the filler is preferred to be 0.01 to 0.3 μm and more preferred to be 0.01 to 0.1 μm. The average particle diameter is a volume-based median diameter when measured using a laser diffraction scattering particle diameter distribution measuring device. When the antifogging agent composition contains the filler, the content of the filler is preferred to be 1 to 20 parts by mass and more preferred to be 1 to 10 parts by mass relative to total 100 parts by mass of the epoxy resin component. When the content of the filler is 1 part by mass or more, a resin curing shrinkage reducing effect tends to improve, and when it is 20 parts by mass or less, a space for absorbing water of the antifogging layer can be secured sufficiently and the antifogging property tends to improve.

The antifogging agent composition may contain the leveling agent. When the antifogging agent composition contains the leveling agent, the thickness of the formed antifogging layer tends to be uniform, so that perspective distortion of an antifogging article tends to be suppressed. As the leveling agent, a silicone-based leveling agent, a fluorine-based leveling agent, and the like can be cited, and the silicone-based leveling agent is preferred. As the silicone-based leveling agent, there can be cited an amino-modified silicone, a carbonyl-modified silicone, an epoxy-modified silicone, a polyether-modified silicone, an alkoxy-modified silicone, and the like.

When the antifogging agent composition contains the leveling agent, the content of the leveling agent is preferred to be 0.02 to 1 part by mass, more preferred to be 0.02 to 0.3 parts by mass, and particularly preferred to be 0.02 to 0.1 parts by mass relative to 100 parts by mass of the solid content of the antifogging agent composition. When the content of the leveling agent is 0.02 parts by mass or more relative to 100 parts by mass of the solid content of the antifogging agent composition, the thickness of the antifogging layer tends to be more uniform, and when it is 1 part by mass or less, occurrence of cloudiness of the antifogging layer tends to be suppressed.

The surfactant is not limited in particular, and a nonionic surfactant, a cationic surfactant, a betaine-based surfactant, and an anionic surfactant can be cited. When the surfactant is a surfactant having an alkyleneoxy chain such as an ethyleneoxy chain or a propyleneoxy chain, hydrophilicity can be given to the antifogging agent composition, and the antifogging property of the antifogging layer tends to improve more, which is therefore preferred.

[Antifogging Article]

An antifogging article of the present invention includes a substrate; and a resin layer disposed on at least a part of a region on the substrate, having a saturated water absorption amount of 50 mg/cm³ or more, and having a Martens hardness of 2 N/mm² or more. The antifogging article is excellent in antifogging property, yellowing resistance, and bleed resistance.

(Substrate)

The substrate is not limited in particular, and there can be cited glass, plastic, metal, ceramics, and combinations of these (for example, a composite material, a laminated material, and the like). Among them, a light-transmitting substrate selected from the group consisting of glass, plastic, and combinations of these is preferred. The shape of the substrate is not limited in particular, and there can be cited a flat plate shape, a shape having curvature in the entire surface or in a part thereof, and the like. The thickness of the substrate is not limited in particular, and can be appropriately selected according to application of the antifogging article. The thickness of the substrate is 1 to 10 mm, for example.

(Resin Layer)

The resin layer (antifogging layer) is disposed on at least a part of a region on the substrate, and is preferably disposed at an area ratio of 75% or more relative to the total area of at least one main surface of the substrate, and is particularly preferably disposed on the entire surface of at least one main surface of the substrate. The thickness of the resin layer is preferred to be 5 to 50 μm and particularly preferred to be 10 to 30 μm. When the thickness of the resin layer is 5 μm or more, a required antifogging property tends to be exhibited sufficiently, and when it is 50 μm or less, peeling resistance with the substrate tends to be exhibited sufficiently.

The saturated water absorption amount of the resin layer disposed on the substrate is 50 mg/cm³ or more, and from the viewpoint of an antifogging property, preferred to be 60 mg/cm³ or more, more preferred to be 75 mg/cm³ or more, and particularly preferred to be 90 mg/cm³ or more. The upper limit of the saturated water absorption amount is not limited in particular, and from the viewpoint of durability, preferred to be 185 mg/cm³ or less, for example, and particularly preferred to be 155 mg/cm³ or less.

Incidentally, the saturated water absorption amount is a value calculated by the following procedures. The antifogging article is immersed in a distilled water at 25° C. for 10 minutes, redundant moisture is wiped off with a paper towel to the degree that the moisture cannot be recognized visually, and a moisture amount (A) of the entire substrate with the resin layer is measured using a micro moisture analyzer. Further, a moisture amount (B) of only the above-described substrate (without the resin layer) is measured by the same procedures. A value obtained by dividing a value obtained by subtracting the moisture amount (B) from the above-described moisture amount (A) by the volume of the resin layer is set as the saturated water absorption amount of the resin layer. Regarding the measurement of the moisture amount by the micro moisture analyzer, a measurement sample is heated at 120° C., moisture emitted from the sample is adsorbed by molecular sieves in the micro moisture analyzer, and a change in mass of the molecular sieves is measured as the moisture amount. The measurement is performed for the same time period as blank measurement, and the maximum value during that period is employed as the moisture amount.

Further, the Martens hardness of the resin layer disposed on the substrate is 2 N/mm² or more, and from the viewpoint of abrasion resistance, preferred to be 4 N/mm² or more, more preferred to be 6 N/mm² or more, and particularly preferred to be 10 N/mm² or more. The upper limit of the Martens hardness is not limited in particular, and from the viewpoint of maintaining the antifogging property, preferred to be 200 N/mm² or less, for example, and particularly preferred to be 150 N/mm² or less.

Incidentally, the Martens hardness of the resin layer is a measurement value measured in the following manner. After the antifogging article is left in an environment of 20° C. and a relative humidity of 50% for 1 hour, the Martens hardness of the resin layer on the substrate is measured using a micro hardness testing instrument (Fischer Technology, Inc. PICODENTOR) under conditions of a load rate and unload rate F=0.05 mN/5 s and a creep C=5 s.

Of the resin layer disposed on the substrate, the yellowness index measured in conformity with JIS Z8722 is preferred to be 3 or less and particularly preferred to be 1.5 or less. When the yellowness index is small, an external appearance of the antifogging article is excellent. Incidentally, the yellowness index (YI) is measured in the following manner using a colour meter (TM-type spectrophotometric colorimeter SM-T45 manufactured by Suga Test Instruments Co., Ltd., transmitted light). The yellowness index of the substrate and the yellowness index of the antifogging article after the resin layer is formed on the substrate are measured, and the yellowness index of the resin layer is calculated by subtracting the yellowness index of the substrate from the yellowness index of the antifogging article.

The resin layer of the antifogging article is preferred to be a cured product of the already-described antifogging agent composition. When the resin layer is the cured product of the antifogging agent composition, desired saturated water absorption amount and Martens hardness can be achieved easily. A method of forming the resin layer using the antifogging agent composition will be described later.

The antifogging article may have a primer layer between the substrate and the resin layer. By having the primer layer, adhesiveness between the substrate and the resin layer improves more. As the primer layer, a thin film of a metal oxide such as silica, alumina, titania, zirconia, or the like and a metal oxide thin film containing an organic group can be cited. The thin film of the metal oxide can be formed using a metal compound having a hydrolyzable group by a sol-gel method. As the metal compound, tetraalkoxysilane and an oligomer thereof, tetraisocyanatesilane and an oligomer thereof, and the like are preferred. The metal oxide thin film containing an organic group is a thin film that can be obtained by treating the surface of the substrate with an organic metal-based coupling agent. As the organic metal-based coupling agent, it is possible to use a silane coupling agent, a titanium coupling agent, an aluminum coupling agent, or the like, and the silane coupling agent is preferred particularly.

[Manufacturing Method of the Antifogging Article]

A manufacturing method of the antifogging article of the present invention includes, applying the antifogging agent composition on the substrate; and heating the applied antifogging agent composition. The manufacturing method may include other operations as necessary. By the heating treatment, the epoxy resin component containing the water-soluble epoxy resin contained in the antifogging agent composition is cured and the resin layer being the cured product of the antifogging agent composition is formed.

A method of applying the antifogging agent composition on the substrate is not limited in particular, and can be appropriately selected from normally used liquid application methods according to the shape of the substrate or the like. As the application method, spin coating, dip coating, spray coating, flow coating, die coating, and the like can be cited specifically, and the flow coating, the spin coating, and the like are preferred.

An applied amount of the antifogging agent composition to be applied on the substrate is not limited in particular as long as it is an amount to be a desired thickness after the heating treatment, and can be appropriately selected according to a purpose or the like. The applied amount of the antifogging agent composition is preferably set to 1.6 to 1,600 g/m², and more preferably set to 8.0 to 800 g/m² as a solid content.

The heating treatment of the applied antifogging agent composition can be performed by an arbitrary heating device such as an electric furnace, a gas furnace, or an infrared heating furnace that is set to a predetermined temperature. A heating treatment temperature is preferred to be, for example, 70 to 300° C., more preferred to be 80 to 280° C., and particularly preferred to be 100 to 250° C. When the heat treatment temperature is 70° C. or more, there is a tendency that a decrease in adhesion strength caused by insufficient reaction of the resin component does not occur, and when it is 300° C. or less, occurrence of discoloring tends to be suppressed. A heating treatment time can be appropriately set according to the heat treatment temperature, and is preferred to be 1 to 180 minutes and more preferred to be 5 to 120 minutes. When the heating treatment time is 1 minute or more, there is a tendency that a decrease in adhesion strength caused by insufficient reaction of the resin component does not occur, and when it is 180 minutes or less, discoloring of the resin tends to be suppressed.

[Application of the Antifogging Article]

As application of the antifogging article, there can be cited window glasses for transformation machines (such as automobiles, trains, ships, and airplanes), refrigerating·freezing showcases, refrigerating·freezing reach-in doors, washstand mirrors, bathroom mirrors, optical apparatuses, and the like.

### EXAMPLE

Hereinafter, the present invention will be further explained by examples, but the present invention is not limited to these examples. Note that Examples 1 to 10 to be explained below are examples and Examples 11 to 15 are comparative examples.

Abbreviations and physical properties of compounds used in examples and comparative examples were summarized below.

### (1) Epoxy Resin

### (1-1) Water-Soluble Epoxy Resin

EX1610: Denacol EX-1610 (trade name, made by Nagase ChemteX Corporation, aliphatic polyglycidyl ether, water-soluble rate=100%)

EX313: Denacol EX-313 (trade name, made by Nagase ChemteX Corporation, glycerol polyglycidyl ether, water-soluble rate=99%)

### (1-2) Water-Insoluble Epoxy Resin

EP4100: ADEKA RESIN EP4100 (trade name, made by ADEKA CORPORATION, bisphenol A diglycidyl ether, water-soluble rate=insoluble (“insoluble” indicates that water-soluble rate is less than 20%)

### (2) Aluminum Compound

Al(acac)₃; tris(2,4-pentanedionato)aluminum (III) (made by KANTO CHEMICAL CO., INC.)

ALCH: aluminum ethylacetoacetate diisopropylate (made by Kawaken Fine

Chemicals Co., Ltd.)

ALCH-TR: aluminum tris(ethylacetoacetate) (made by Kawaken Fine Chemicals Co., Ltd.)

### (3) Alkoxysilane Compound

GPTMS: 3-glycidoxypropyltrimethoxysilane (made by JNC CORPORATION: Sila-Ace S501)

APTMS: 3-aminopropyltrimethoxysilane (made by Shin-Etsu Chemical Co., Ltd.: KBM903)

### (4) Curing Agent or Curing Catalyst

NH₄ClO₄: ammonium perchlorate (made by Wako Pure Chemical Industries, Ltd.)

T403: JEFFAMINE T403, polyoxyalkylene triamine (made by Huntsman)

2MZ: 2-methylimidazole (made by SHIKOKU CHEMICALS CORPORATION)

### (5) Liquid Medium

SOLMIX AP-1: made by JAPAN ALCOHOL TRADING COMPANY LIMITED, a mixed solvent of ethanol: 2-propanol: methanol=85.5: 13.4: 1.1 (mass ratio)

PIP: made by DAISHIN CHEMICAL CO., LTD., a mixed solvent of ethanol: 2-propanol: 1-propanol=88:4:8 (mass ratio)

### (6) Filler

MEK-ST: a silica particle dispersed material, made by NISSAN CHEMICAL INDUSTRIES, LTD., SiO₂ content 30 mass %

### (7) Surfactant

BYK307: a mixture of polyether-modified polydimethylsiloxane and polyether, made by BYK.

Evaluations of antifogging articles in respective examples were performed as follows.

### [Curability]

Sensory evaluation of a resin layer after curing was performed by finger touch. The evaluation was performed in a manner that a touch-drying state was set as A, a slight tacky state was set as B, and a not touch-drying and tacky state was set as C.

[Film Thickness]

A cross-sectional image of the antifogging article was photographed by a scanning electron microscope (made by Hitachi, Ltd., S4300), and the film thickness of the resin layer was measured.

[Antifogging Performance]

The surface of the antifogging article with the resin layer provided thereon after the antifogging article was left in an environment of 20° C. and a relative humidity of 50% for 1 hour was held at a position of 8.5 cm above a hot water bath of 35° C., and an antifogging time (second) until fogging is recognized visually was measured. Fogging occurred in 1 to 2 seconds on a normal soda lime glass that was not subjected to an antifogging process. The required antifogging performance differs depending on application. In examples, practically, a water absorbing and antifogging property of 50 seconds or more is preferred, it is more preferred to be 80 seconds or more, and it is particularly preferred to be 100 seconds or more.

[Saturated Water Absorption Amount]

The resin layer is provided on a soda lime glass substrate of 3 cm×4 cm×2 mm in thickness, and this is immersed in a distilled water at 25° C. for 10 minutes, redundant moisture is wiped off with a KIM TOWEL to the degree that the moisture cannot be recognized visually, and the moisture amount (A) of the entire substrate with the resin layer is measured using a micro moisture analyzer. Further, the moisture amount (B) of only the above-described substrate (without the resin layer) is measured by the same procedures. A value obtained by dividing a value obtained by subtracting the moisture amount (B) from the above-described moisture amount (A) by the volume of the resin layer is set as the saturated water absorption amount of the resin layer. Note that the measurement of moisture amount is performed as follows by a micro moisture analyzer FM-300 (made by Kett Electric Laboratory). A measurement sample is heated at 120° C., moisture emitted from the measurement sample is adsorbed by molecular sieves in the micro moisture analyzer, and a change in mass of the molecular sieves is measured as the moisture amount. The measurement is performed for the same time period as blank measurement, and the maximum value during that period is employed as the moisture amount.

[Yellowing Resistance]

In conformity with the standard of JIS Z8722, the yellowness index (YI) of the antifogging article was measured using a colour meter (TM-type spectrophotometric colorimeter SM-T45 made by Suga Test Instruments Co., Ltd., transmitted light). The measurement was performed by setting YI of the substrate as YI (1) and setting YI after the resin layer being formed on the substrate as YI (2). A value obtained by subtracting YI (1) from YI (2) was taken as YI of the resin layer and it was set as the index of the yellowing resistance.

[Film Hardness]

After the antifogging article was left in an environment of 20° C. and a relative humidity of 50% for 1 hour, the Martens hardness of the resin layer was measured using a micro hardness testing instrument (Fischer Technology, Inc. PICODENTOR) under conditions of a load rate and unload rate F=0.05 mN/5 s and a creep C=5 s, and the resultant was set as the film hardness.

[Bleed Resistance]

The surface of the antifogging article with the resin layer provided thereon after the antifogging article was left in an environment of 20° C. and a relative humidity of 50% for 1 hour was held at a position of 8.5 cm above a hot water bath of 35° C. for 30 minutes, and then the surface was observed visually, and the evaluation was performed in a manner that the case where on the resin layer surface, there are neither precipitates nor distortion after wiping off redundant moisture with a KIM TOWEL is set as A, the case where on the resin layer surface, there are/is slight precipitates or slight distortion after wiping off is set as B, and the case where there are/is precipitates or distortion after wiping off is set as C.

### Preparation Example

### (Sol-Gel Hydrolyzed Composition)

Into a glass container with a stirrer and a thermometer set therein, 36.7 g of SOLMIX AP-1, 39.3 g of 3-glycidoxypropyltrimethoxysilane, and 24.0 g of 0.1 mol/L nitric acid (made by JUNSEI CHEMICAL CO., LTD.) were put and stirred at 25° C. for 1 hour to obtain a sol-gel hydrolyzed composition containing a partially hydrolyzed condensate of an alkoxysilane compound.

(Curing Catalyst Dilution A1)

Into a glass container with a stirrer and a thermometer set therein, 3.0 g of Al(acac)₃ and 97.0 g of methanol (JUNSEI CHEMICAL CO.,LTD.; special grade) were put and stirred at 25° C. for 10 minutes to obtain a curing catalyst dilution A1 being an aluminum compound solution.

(Curing Catalyst Dilution A2)

Into a glass container with a stirrer and a thermometer set therein, 2.54 g of ALCH and 97.46 g of methanol (JUNSEI CHEMICAL CO.,LTD.; special grade) were put and stirred at 25° C. for 10 minutes to obtain a curing catalyst dilution A2 being an aluminum compound solution.

(Curing Catalyst Dilution A3)

Into a glass container with a stirrer and a thermometer set therein, 3.83 g of ALCH-TR and 96.17 g of methanol (JUNSEI CHEMICAL CO.,LTD.; special grade) were put and stirred at 25° C. for 10 minutes to obtain a curing catalyst dilution A3 being an aluminum compound solution.

### Example 1

Into a glass container with a stirrer and a thermometer set therein, 30.7 g of EX1610, 8.7 g of the sol-gel hydrolyzed composition, 31.5 g of the curing catalyst dilution Al, and 29.1 g of SOLMIX AP-1 were put and stirred at 25° C. for 10 minutes to obtain an antifogging agent composition for forming an antifogging layer. Thereafter, a dried clean soda lime glass substrate (water contact angle 3°, 100 mm×100 mm×3.5 mm in thickness) whose surface was polished and cleaned with cerium oxide was used as the substrate, and the antifogging agent composition was applied by spin coating on the surface of the glass substrate. Then, it was held for 30 minutes in an electric furnace at 200° C., to thereby obtain an antifogging article having an antifogging layer.

### Example 2

An antifogging article having an antifogging layer was obtained similarly to Example 1 except that 24.5 g of EX1610, 6.1 g of EP4100, 8.7 g of the sol-gel hydrolyzed composition, 31.5 g of the curing catalyst dilution A1, and 29.1 g of SOLMIX AP-1 were put and stirred at 25° C. for 10 minutes, to thereby obtain an antifogging agent composition in Example 1.

### Example 3

An antifogging article having an antifogging layer was obtained similarly to Example 1 except that 18.4 g of EX1610, 12.3 g of EP4100, 8.7 g of the sol-gel hydrolyzed composition, 31.5 g of the curing catalyst dilution A1, and 29.1 g of SOLMIX AP-1 were put and stirred at 25° C. for 10 minutes, to thereby obtain an antifogging agent composition in Example 1.

### Example 4

An antifogging article having an antifogging layer was obtained similarly to Example 1 except that 23.5 g of EX1610, 5.9 g of EP4100, 12.2 g of the sol-gel hydrolyzed composition, 30.3 g of the curing catalyst dilution A1, and 28.1 g of SOLMIX AP-1 were put and stirred at 25° C. for 10 minutes, to thereby obtain an antifogging agent composition in Example 1.

### Example 5

An antifogging article having an antifogging layer was obtained similarly to Example 1 except that 24.3 g of EX1610, 6.1 g of EP4100, 8.7 g of the sol-gel hydrolyzed composition, 40.8 g of the curing catalyst dilution A1, and 40.8 g of SOLMIX AP-1 were put and stirred at 25° C. for 10 minutes, to thereby obtain an antifogging agent composition in Example 1.

### Example 6

An antifogging article having an antifogging layer was obtained similarly to Example 1 except that 25.0 g of EX1610, 6.2 g of EP4100, 8.9 g of the sol-gel hydrolyzed composition, 10.5 g of the curing catalyst dilution A1, and 49.4 g of SOLMIX AP-1 were put and stirred at 25° C. for 10 minutes, to thereby obtain an antifogging agent composition in Example 1.

### Example 7

An antifogging article having an antifogging layer was obtained similarly to Example 1 except that 21.0 g of EX1610, 5.3 g of EP4100, 22.4 g of the sol-gel hydrolyzed composition, 26.3 g of the curing catalyst dilution A1, and 25.1 g of SOLMIX AP-1 were put and stirred at 25° C. for 10 minutes, to thereby obtain an antifogging agent composition in Example 1.

### Example 8

Into a glass container with a stirrer and a thermometer set therein, 21.0 g of EX1610, 5.3 g of EP4100, 22.4 g of the sol-gel hydrolyzed composition, 26.3 g of the curing catalyst dilution A1, and 25.1 g of SOLMIX AP-1 were put and stirred at 25° C. for 10 minutes, to thereby obtain an antifogging agent composition. Thereafter, a dried clean soda lime glass substrate (water contact angle 3°, 100 mm×100 mm×3.5 mm in thickness) whose surface was polished and cleaned with cerium oxide was used as the substrate, and the antifogging agent composition was applied by spin coating on the surface of the glass substrate and held for 30 minutes in an electric furnace at 100° C., to thereby obtain an antifogging article having an antifogging layer.

### Example 9

An antifogging article having an antifogging layer was obtained similarly to Example 1 except that 24.6 g of EX1610, 6.2 g of EP4100, 8.7 g of the sol-gel hydrolyzed composition, 26.8 g of the curing catalyst dilution A2, and 33.7 g of SOLMIX AP-1 were put and stirred at 25° C. for 10 minutes, to thereby obtain an antifogging agent composition in Example 1.

### Example 10

An antifogging article having an antifogging layer was obtained similarly to Example 1 except that 24.4 g of EX1610, 6.1 g of EP4100, 8.6 g of the sol-gel hydrolyzed composition, 39.7 g of the curing catalyst dilution A3, and 21.3 g of SOLMIX AP-1 were put and stirred at 25° C. for 10 minutes, to thereby obtain an antifogging agent composition in Example 1.

### Example 11

An antifogging article having an antifogging layer was obtained similarly to Example 1 except that 25.2 g of EX1610, 6.3 g of EP4100, 9.0 g of the sol-gel hydrolyzed composition, and 59.5 g of SOLMIX AP-1 were put and stirred at 25° C. for 10 minutes, to thereby obtain an antifogging agent composition in Example 1.

### Example 12

An antifogging article having an antifogging layer was obtained similarly to Example 1 except that 27.2 g of EX1610, 6.8 g of EP4100, 33.8 g of the curing catalyst dilution A1, and 32.2 g of SOLMIX AP-1 were put and stirred at 25° C. for 10 minutes, to thereby obtain an antifogging agent composition in Example 1.

### Example 13

An antifogging article having an antifogging layer was obtained similarly to Example 1 except that 25.1 g of EX1610, 6.3 g of EP4100, 8.9 g of the sol-gel hydrolyzed composition, 0.3 g of ammonium perchlorate, and 59.6 g of SOLMIX AP-1 were put and stirred at 25° C. for 10 minutes, to thereby obtain an antifogging agent composition in Example 1.

### Example 14

Into a glass container with a stirrer and a thermometer set therein, 33.55 g of PIP, 11.0 g of EX1610, 9.1 g of EX313, 0.5 g of 2 MZ, 4.0 g of JEFFAMINE T403, and 4.1 g of APTMS were added while stirring, and stirred at 25° C. for 1 hour. Then, 17.2 g of PIP, 10.6 g of MEK-ST, and 0.04 g of BYK307 were added thereinto while stirring, to thereby obtain an antifogging agent composition. Thereafter, a dried clean soda lime glass substrate (water contact angle 3°, 100 mm×100 mm×3.5 mm in thickness) whose surface was polished and cleaned with cerium oxide was used as the substrate, and the antifogging agent composition was applied by spin coating on the surface of the glass substrate and held for 30 minutes in an electric furnace at 100° C., to thereby obtain an antifogging article having an antifogging layer.

### Example 15

An antifogging article having an antifogging layer was obtained similarly to Example 1 except that 25.2 g of EX1610, 6.3 g of phloroglucinol, 9.0 g of the sol-gel hydrolyzed composition, and 59.5 g of SOLMIX AP-1 were put and stirred at 25° C. for 10 minutes, to thereby obtain an antifogging agent composition in Example 1.

Solid content compositions (mass %) of the antifogging agent compositions obtained in the above-described respective examples are illustrated in Table 1. In Table 1, “-” indicates not-added. Further, on the obtained antifogging articles, the evaluations were performed by the above-described evaluation methods. Evaluation results are illustrated in Table 2. In Table 2, “-” indicates not-evaluated. In Table 1 and Table 2, “Ex” means Example.

TABLE 1

| | | | | Alkoxysilane | | | | | | | | |
|---|---|---|---|---|---|---|---|---|---|---|---|---|
| | | | | compound and the like | | | | | | | | |
| | Epoxy resin | | | GPTMS | | | | | | | | |
| | | | Water | Partially | | Aluminum compound | | | Curing agent/Curing catalyst | | | |
| | Water soluble | | insoluble | hydrolyzed | | | | ALCH- | | | | Phloro- |
| | EX1610 | EX313 | EP4100 | condensate | APTMS | Al(acac)₃ | ALCH | TR | NH₄ClO₄ | T403 | 2MZ | glucinol |
| Ex1 | 87.6 | — | — | 9.7 | — | 2.7 | — | — | — | — | — | — |
| Ex2 | 70.1 | — | 17.5 | 9.7 | — | 2.7 | — | — | — | — | — | — |
| Ex3 | 52.5 | — | 35.1 | 9.7 | — | 2.7 | — | — | — | — | — | — |
| Ex4 | 67.0 | — | 16.8 | 13.6 | — | 2.6 | — | — | — | — | — | — |
| Ex5 | 69.4 | — | 17.4 | 9.7 | — | 3.5 | — | — | — | — | — | — |
| Ex6 | 71.4 | — | 17.8 | 9.9 | — | 0.9 | — | — | — | — | — | — |
| Ex7 | 58.7 | — | 14.7 | 24.4 | — | 2.2 | — | — | — | — | — | — |
| Ex8 | 58.7 | — | 14.7 | 24.4 | — | 2.2 | — | — | — | — | — | — |
| Ex9 | 70.4 | — | 17.6 | 9.7 | — | — | 2.3 | — | — | — | — | — |
| Ex10 | 69.6 | — | 17.4 | 9.6 | — | — | — | 3.4 | — | — | — | — |
| Ex11 | 72.0 | — | 18.0 | 10.0 | — | — | — | — | — | — | — | — |
| Ex12 | 77.7 | — | 19.4 | — | — | 2.9 | — | — | — | — | — | — |
| Ex13 | 71.7 | — | 17.9 | 9.9 | — | — | — | — | 0.5 | — | — | — |
| Ex14 | 39.5 | 32.9 | — | — | 11.5 | — | — | — | — | 1.8 | 14.3 | — |
| Ex15 | 72.1 | — | — | 10.0 | — | — | — | — | — | — | — | 17.9 |

TABLE 2

| | | | | | Saturated | | | |
|---|---|---|---|---|---|---|---|---|
| | Curing | | Film | | water | | | |
| | temper- | | thick- | Antifogging | absorption | | Film | |
| | ature | Cura- | ness | performance | amount | Yellowing | hardness | Bleed |
| | [° C.] | bility | [μm] | [second] | [mg/cm³] | resistance | [N/mm²] | resistance |
| Ex1 | 200 | A | 17.3 | 140 | 215 | 0.2 | 84 | A |
| Ex2 | 200 | A | 17.8 | 100 | 149 | 0.3 | 87 | A |
| Ex3 | 200 | A | 18.4 | 80 | 118 | 0.2 | 93 | A |
| Ex4 | 200 | A | 17.5 | 68 | 93 | 0.3 | 106 | A |
| Ex5 | 200 | A | 17.2 | 90 | 160 | 0.4 | 87 | A |
| Ex6 | 200 | A | 18.5 | 160 | 241 | 0.2 | 10 | A |
| Ex7 | 200 | A | 16.3 | 61 | 119 | 0.4 | 111 | A |
| Ex8 | 100 | A | 18.1 | 77 | 137 | 0.2 | 40 | A |
| Ex9 | 200 | A | 18.2 | 69 | 125 | 0.3 | 110 | A |
| Ex10 | 200 | A | 18.0 | 94 | 177 | 0.4 | 97 | A |
| Ex11 | 200 | C | — | — | — | — | — | — |
| Ex12 | 200 | C | — | — | — | — | — | — |
| Ex13 | 200 | A | 17.9 | 67 | 104 | 3.2 | 133 | C |
| Ex14 | 100 | A | 17.2 | 140 | 212 | 13.5 | 3 | C |
| Ex15 | 200 | A | 18.1 | 88 | 150 | 22.4 | 106 | C |

Table 2 reveals that the antifogging layers of the antifogging articles in Examples 1 to 10 being the example are excellent in yellowing resistance and bleed resistance and are further excellent in film hardness and antifogging performance. In the meantime, in Examples 11 and 12 not containing the aluminum compound or the alkoxysilane compound, the curability was insufficient. In Examples 11 and 12, the resin layer was not sufficiently cured, so that it was not possible to perform evaluations of the antifogging performance and the like. Further, Examples 13 to 15 using the curing catalyst or curing agent in place of the aluminum compound resulted in being poor in yellowing resistance and bleed resistance.

1. An antifogging agent composition comprising:
a water-soluble epoxy resin;
an aluminum compound; and
an alkoxysilane compound and/or a partially hydrolyzed condensate of an alkoxysilane compound,
wherein the water-soluble epoxy resin is a polyfunctional aliphatic epoxy resin.

2. The antifogging agent composition according to claim 1, wherein the aluminum compound is a compound represented by formula (I),
AlXₙY₍₃₋ₙ₎ (I)
where X each independently represents an alkoxy group having 1 to 4 carbon atoms, and Y is each independently a ligand derived from a compound selected from the group consisting of M¹COCH₂COM² and M³COCH₂COOM⁴, where M¹, M², and M³ each independently represent an alkyl group having 1 to 4 carbon atoms and M⁴ represents a hydrogen atom or an alkyl group having 1 to 4 carbon atoms, and n represents a number of 0 to 2.

3. The antifogging agent composition according to claim 1, wherein the alkoxysilane compound is a compound represented by formula (II),
(R¹O)ₚSiR²₍₄₋ₚ₎ (II)
where R¹ each independently represents an alkyl group having 1 to 4 carbon atoms, R² each independently represents an alkyl group having 1 to 10 carbon atoms that may have a substituent, and p represents a number of 1 to 4.

4. An antifogging article comprising:
a substrate; and
a resin layer disposed on at least a part of a region on the substrate, having a saturated water absorption amount of 50 mg/cm³ or more, and having a Martens hardness of 2 N/mm² or more.

5. The antifogging article according to claim 4,
wherein the resin layer is a cured product of an antifogging agent composition comprising:
a water-soluble epoxy resin;
an aluminum compound; and
an alkoxysilane compound and/or a partially hydrolyzed condensate of an alkoxysilane compound,
wherein the water-soluble epoxy resin is a polyfunctional aliphatic epoxy resin.

6. A method of manufacturing an antifogging article, comprising:
applying the antifogging agent composition according to claim 1 on a substrate; and
heating the applied antifogging agent composition.
